(19) United States
(12) Patent Application Publication
(10) Pub. No.: US 2019/0310573 A1
(43) Pub. Date: Oct. 10, 2019

(54) FIXING DEVICE AND IMAGE FORMING APPARATUS

(71) Applicant: Konica Minolta, Inc., Tokyo (JP)

(72) Inventor: Hiromitsu ONAKA, Toyokawa-shi (JP)

(21) Appl. No.: 16/361,102

(22) Filed: Mar. 21, 2019

(30) Foreign Application Priority Data
Apr. 6, 2018 (JP) 2018-073762

(51) Int. Cl. G03G 15/20

(52) U.S. Cl. CPC G03G 15/2028; G03G 15/2053

(57) ABSTRACT

A fixing device includes: a fixing belt; a nip formation member; a rotation body; and a heater. The nip formation member is disposed at an inner circumferential side of the fixing belt. The rotation body is configured to form a fixing nip portion with the rotation body facing the nip formation member. The heater is configured to supply heat to the toner image. The nip formation member includes a path adjustment surface having a portion corresponding to a most downstream portion of the fixing nip portion in a transportation direction of the recording medium. In a cross section of the nip formation member orthogonal to a width direction of the fixing belt, a length of the path adjustment surface in a direction along the path adjustment surface is less than or equal to ⅓ of a length of the fixing nip portion in the transportation direction.

The entire disclosure of Japanese Patent Application No. 2018-073762, filed on Apr. 6, 2018, is incorporated herein by reference in its entirety.

### BACKGROUND

### Technological Field

The present invention relates to a fixing device and an image forming apparatus.

### Description of the Related Art

Each of Japanese Laid-Open Patent Publication No. 2005-221533, Japanese Laid-Open Patent Publication No. 2014-6317 and Japanese Laid-Open Patent Publication No. 2013-186197, and Japanese Laid-Open Patent Publication No. 2017-9824 discloses a technique for separating a recording medium, which has passed through a nip portion, from a fixing belt and stabilizing an ejection direction of the recording medium in a conventional fixing device.

### SUMMARY

In the conventional fixing device disclosed in each of Japanese Laid-Open Patent Publication No. 2005-221533, Japanese Laid-Open Patent Publication No. 2014-6317, and Japanese Laid-Open Patent Publication No. 2013-186197, an excessive amount of heat is supplied to a toner image on the recording medium during a period of time until the recording medium is separated from the fixing belt, with the result that a decreased gloss level, hot offset, or the like may occur.

On the other hand, in the conventional fixing device disclosed in Japanese Laid-Open Patent Publication No. 2017-9824, a separation member including a separate roller is disposed near an exit of the nip portion, whereby separability is attained while suppressing hot offset or the like. However, a configuration of the fixing device as a whole becomes complicated.

In the present disclosure, a fixing device and an image forming apparatus are provided, by each of which an excessive amount of heat can be suppressed in a simplified manner from being supplied to a toner image, while securing separability.

To achieve at least one of the abovementioned objects, according to an aspect of the present invention, a fixing device, for fixing a toner image to a recording medium, reflecting one aspect of the present invention comprises: a fixing belt having an endless form and configured to be rotatable; a nip formation member; a rotation body; and a heater. The nip formation member is disposed at an inner circumferential side of the fixing belt. The rotation body is configured to form a fixing nip portion with the rotation body facing the nip formation member and facing an outer circumferential surface of the fixing belt. The heater is configured to supply heat to the toner image. The nip formation member includes a path adjustment surface having a portion corresponding to a most downstream portion of the fixing nip portion in a transportation direction of the recording medium. In a cross section of the nip formation member orthogonal to a width direction of the fixing belt, a length of the path adjustment surface in a direction along the path adjustment surface is less than or equal to ⅓ of a length of the fixing nip portion in the transportation direction.

To achieve at least one of the abovementioned objects, according to an aspect of the present invention, an image forming apparatus reflecting one aspect of the present invention comprises: the above-described fixing device; and an accommodation portion configured to store the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic view of an image forming apparatus according to a first embodiment.

FIG. 2 is a schematic cross sectional view of a fixing device in the first embodiment.

FIG. 3 shows an overview of a configuration of the fixing device when seen in an III direction in FIG. 2.

FIG. 4 is an enlarged schematic view of a region IV shown in FIG. 2.

FIG. 5 is a schematic cross sectional view of a nip formation member in the first embodiment.

FIG. 6 is a schematic cross sectional view showing a fixing device in a second embodiment.

FIG. 7 shows a table illustrating evaluation results on nip formation members of Example 1, Example 2, and Comparative Example 1 to Comparative Example 4.

FIG. 8 shows a graph collectively illustrating results of the Examples and the Comparative Examples.

### DETAILED DESCRIPTION OF EMBODIMENTS

Hereinafter, one or more embodiments of the present invention will be described with reference to the drawings. However, the scope of the invention is not limited to the disclosed embodiments.

In embodiments described below, a tandem type color printer employing an electrophotography method and a fixing device provided therein will be illustratively described as an image forming apparatus and a fixing device, respectively. It should be noted that in the embodiments described below, the same or common portions are given the same reference characters in the figures and are not described repeatedly.

### First Embodiment

<Image Forming Apparatus 100>

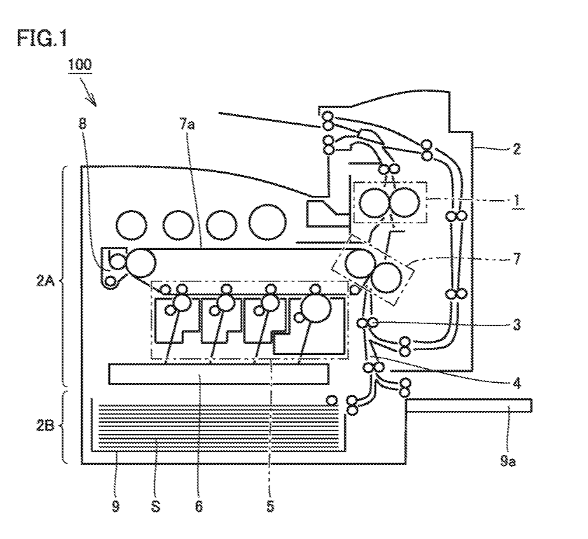

FIG. 1 is a schematic view of an image forming apparatus 100 according to a first embodiment. With reference to FIG. 1, the following describes schematic configuration and operation of image forming apparatus 100 in the embodiment.

Image forming apparatus 100 mainly includes an apparatus main body 2 and an accommodation portion 9. Apparatus main body 2 includes: an image forming portion 2A, which is a portion for forming an image on a sheet S serving as a recording medium; and a sheet supply portion 2B, which is a portion for supplying sheet S to image forming portion 2A. Accommodation portion 9 is configured to store sheet S to be supplied to image forming portion 2A, and is detachably provided at sheet supply portion 2B.

In image forming apparatus 100, a plurality of rollers 3 are disposed, whereby a transportation path 4 in which sheet S is transported along a predetermined direction is constructed to range over image forming portion 2A and sheet supply portion 2B. Moreover, as shown in FIG. 1, apparatus main body 2 may be separately provided with a manual tray 9a for supplying sheet S to image forming portion 2A.

For example, image forming portion 2A mainly includes: an imaging unit 5 configured to form a toner image of each of colors of yellow (Y), magenta (M), cyan (C), and black (K); an exposure unit 6 for exposing a photoconductor included in imaging unit 5 to light; an intermediate transfer belt 7a tensioned and laid on imaging unit 5; a transfer portion 7 provided on transportation path 4 and on a traveling path of intermediate transfer belt 7a; a cleaning portion 8; and a fixing device 1 according to the embodiment, fixing device 1 being provided on transportation path 4 at a portion at the downstream side relative to transfer portion 7.

Imaging unit 5 is exposed to light from exposure unit 6 to form, on a surface of the photoconductor, a toner image of each color of yellow (Y), magenta (M), cyan (C), and black (K) or a toner image of only black (K) and transfers the toner image to intermediate transfer belt 7a (primary transfer). Accordingly, a color toner image or a monochrome toner image is formed on intermediate transfer belt 7a.

Intermediate transfer belt 7a conveys, to transfer portion 7, the color toner image or monochrome toner image formed on the surface thereof. At transfer portion 7, the color toner image or monochrome toner image is pressed against sheet S transported from sheet supply portion 2B to transfer portion 7. Accordingly, the color toner image or monochrome toner image formed on the surface of intermediate transfer belt 7a is transferred to sheet S (secondary transfer).

After transferring the color toner image or monochrome toner image to sheet S by transfer portion 7, residual toner is removed by cleaning portion 8 from intermediate transfer belt 7a from which sheet S has been separated due to self stripping.

Sheet S having the color toner image or monochrome toner image transferred thereon is then pressed and heated by fixing device 1, thereby fixing the toner image on sheet S. In this way, the color image or monochrome image is formed on sheet S, and sheet S having the color image or monochrome image formed thereon is then ejected from apparatus main body 2.

(Fixing Device 1)

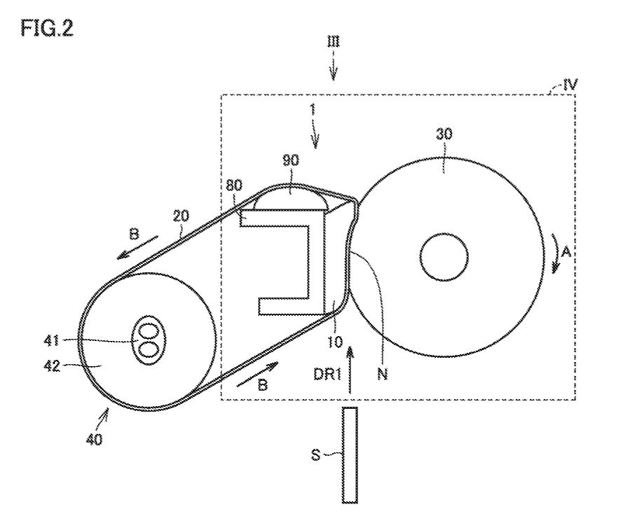

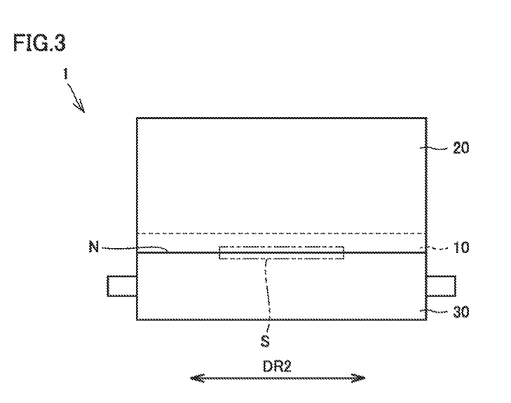

FIG. 2 is a schematic cross sectional view of fixing device 1 in the first embodiment. FIG. 3 shows an overview of a configuration of fixing device 1 when seen in an III direction in FIG. 2. With reference to FIG. 2 and FIG. 3, fixing device 1 will be described. Fixing device 1 includes: a fixing belt 20 having an endless form and configured to be rotatable; a heater 40; a rotation body; a nip formation member 10; a fixation member 80; and a grease holding member 90.

The outer diameter of fixing belt 20 may be appropriately determined, but is preferably more than or equal to 10 mm and less than or equal to 100 mm. Fixing belt 20 has a base layer, an elastic layer, and a releasing layer. The base layer is composed of polyimide (PI), for example. The thickness of the base layer is more than or equal to 5 μm and less than or equal to 100 μm, for example.

For the elastic layer, a material having a high heat resistance is preferable, such as a silicone rubber or a fluororubber. The thickness of the elastic layer is more than or equal to 10 μm and less than or equal to 300 μm, for example. The releasing layer is preferably a configuration with releasability, such as a fluorine tube or a fluorine-based coating. The thickness of the releasing layer is more than or equal to 5 μm and less than or equal to 100 μm, for example.

Nip formation member 10 is disposed at the inner circumferential side of fixing belt 20. Nip formation member 10 is provided to be fixed by fixation member 80, and the inner circumferential surface of fixing belt 20 slides thereon. Details of nip formation member 10 will be described later.

In the embodiment, the rotation body is a pressure roller 30. Pressure roller 30 is rotated by a driving device (not shown) such as a motor (direction of A in FIG. 2). Fixing belt 20 is rotated according to the rotation of pressure roller 30 (direction of B in FIG. 2).

Pressure roller 30 presses nip formation member 10 with fixing belt 20 being interposed therebetween. Pressure roller 30 forms a fixing nip portion N with pressure roller 30 facing nip formation member 10 and facing the outer circumferential surface of fixing belt 20. Fixing nip portion N is a region formed by pressure roller 30 pressing nip formation member 10. At fixing nip portion N, the toner image on sheet S is heated and pressed and is therefore fixed on sheet S.

The surface hardness of pressure roller 30 is 50°, for example. The surface hardness of pressure roller 30 is preferably more than or equal to 40° and less than or equal to 60° (Asker C). The outer diameter of pressure roller 30 is 32 mm, for example. The outer diameter of pressure roller 30 is preferably more than or equal to 20 mm and less than or equal to 100 mm.

Pressure roller 30 has a core, an elastic layer, and a releasing layer. The core is preferably a metal such as aluminum or iron. The thickness of the core is preferably more than or equal to 0.1 mm and less than or equal to 10 mm. The core may have a pipe shape, a solid rod shape, an odd shape such as a cross sectional shape in the form of three arrows, or the like.

For the elastic layer, a material having a high heat resistance is preferable, such as a silicone rubber or a fluororubber. The thickness of the elastic layer is preferably more than or equal to 1 mm and less than or equal to 20 mm. The releasing layer is preferably a configuration with releasability, such as a fluorine tube. The thickness of the releasing layer is preferably more than or equal to 5 μm and less than or equal to 100 μm.

An arrow shown in FIG. 2 represents a transportation direction DR1. Transportation direction DR1 is the transportation direction of sheet S, and is an upward direction in FIG. 2. A two-way arrow shown in FIG. 3 represents a width direction DR2. Width direction DR2 is a direction orthogonal to transportation direction DR1, and is a width direction of fixing belt 20. Width direction DR2 is a leftward/rightward direction in FIG. 3, and is parallel to the axial direction of pressure roller 30.

Grease holding member 90 is disposed at the downstream side relative to nip formation member 10 in the rotation direction of fixing belt 20. Grease holding member 90 is fixed by fixation member 80. Grease holding member 90 is disposed at the inner circumferential side of fixing belt 20, and supports fixing belt 20. Grease holding member 90 supplies grease to fixing belt 20 while the inner circumferential surface of fixing belt 20 slides thereon.

Heater 40 is disposed at the inner circumferential side of fixing belt 20. Heater 40 has a heat source 41 and a heating roller 42. With radiant heat of heat source 41, heat source 41 heats fixing belt 20 through heating roller 42. Heat source 41 supplies heat to the toner image through fixing belt 20. Fixing belt 20 is tensioned and laid on heating roller 42, nip formation member 10, and grease holding member 90.

A slide member (not shown) is provided between fixing belt 20 and nip formation member 10. In the slide member, a glass cloth is employed as a base member. The slide member is generally configured to have a slide surface coated with a fluorine-based resin. For the slide surface of the slide member, a fluorine fiber fabric, a fluororesin sheet, a glass coat, and the like are used. With the slide member, sliding resistance between fixing belt 20 and nip formation member 10 is decreased, whereby fixing belt 20 is rotated stably.

(Nip Formation Member 10)

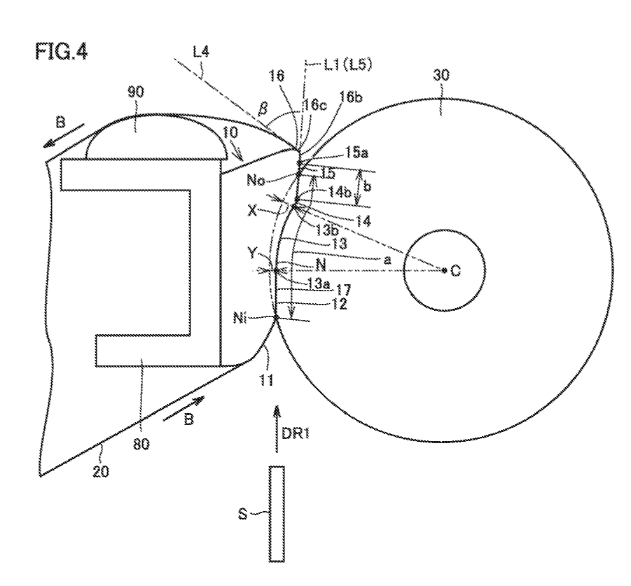

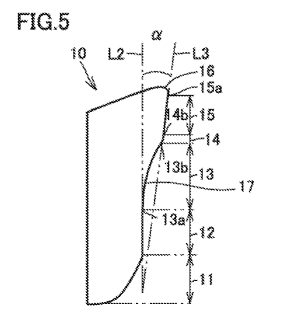

FIG. 4 is an enlarged overview of a region IV shown in FIG. 2. FIG. 5 is a schematic cross sectional view of nip formation member 10 in the first embodiment. FIG. 4 shows pressure roller 30 after elastic deformation; however, for the purpose of understanding of the shape of pressure roller 30 before the elastic deformation, the shape of the elastically deformed portion of pressure roller 30 before the deformation is indicated by a long dashed double-short dashed line, and fixing belt 20 is indicated by a solid line. With reference to FIG. 4 and FIG. 5, nip formation member 10 will be described.

Nip formation member 10 has a facing surface 17. Facing surface 17 faces the inner circumferential surface of fixing belt 20. Facing surface 17 is a surface facing pressure roller 30. The surface of pressure roller 30 is elastically deformed to follow the surface shape of facing surface 17. Facing surface 17 has a curved surface 11, a flat surface portion 12, a curvature surface portion 13, a protruding surface 14, a path adjustment surface 15, and a corner surface 16.

Curved surface 11 is provided at the upstream side relative to fixing nip portion N in transportation direction DR1. Curved surface 11 is provided at the most upstream portion of facing surface 17 in transportation direction DR1. Curved surface 11 has a curved shape. Curved surface 11 has a shape protruding toward the pressure roller 30 side. At the downstream side relative to curved surface 11 in transportation direction DR1, flat surface portion 12 smoothly continuous to curved surface 11 is provided.

Flat surface portion 12 is flat. In the present specification, the expression “flat” is intended to encompass not only a case where a degree of flatness is geometrically zero but also a case where there is a slight curve (substantially flat) (the same applies to the description below with regard to the expression “flat”). Flat surface portion 12 has a shape straightly extending in a cross section (hereinafter, referred to as “cross section Z”) of nip formation member 10 orthogonal to width direction DR2.

Flat surface portion 12 has a portion corresponding to the most upstream portion (hereinafter, referred to as “nip entrance Ni”) of fixing nip portion N in transportation direction DR1. In the present specification, the “portion corresponding to nip entrance Ni” means a portion of facing surface 17 facing nip entrance Ni. In the embodiment, the portion corresponding to nip entrance Ni is provided at a boundary between flat surface portion 12 and curved surface 11, but may be provided in flat surface portion 12 at the downstream side relative to the boundary in transportation direction DR1. Curvature surface portion 13 is provided at the downstream side relative to flat surface portion 12 in transportation direction DR1.

Curvature surface portion 13 has such a shape that curvature surface portion 13 extends to come closer to center C of pressure roller 30 (further bite into the outer circumferential surface of pressure roller 30) as curvature surface portion 13 extends toward the downstream in transportation direction DR1 in cross section Z. Curvature surface portion 13 has a shape curved in the form of a recess. Curvature surface portion 13 has a shape depressed (protruding) toward fixation member 80. Since facing surface 17 is depressed toward fixation member 80, curvature surface portion 13 is formed. The curvature radius of curvature surface portion 13 is larger than the curvature radius of pressure roller 30. In the embodiment, the curvature radius of curvature surface portion 13 is 25 mm and the curvature radius of pressure roller 30 is 16 mm, for example.

Curvature surface portion 13 has an upstream end 13a and a downstream end 13b. Upstream end 13a is an end portion of curvature surface portion 13 at the upstream side in transportation direction DR1. Downstream end 13b is an end portion of curvature surface portion 13 at the downstream side in transportation direction DR1. Curvature surface portion 13 is smoothly continuous to flat surface portion 12 at upstream end 13a.

An amount of elastic deformation of pressure roller 30 at a region at which curvature surface portion 13 and pressure roller 30 are in contact with each other is larger in the direction toward the downstream side in transportation direction DR1. The amount of elastic deformation (X in FIG. 4) of pressure roller 30 at downstream end 13b is larger than the amount of elastic deformation (Y in FIG. 4) of pressure roller 30 at upstream end 13a.

According to the above-mentioned configuration, a nip pressure in curvature surface portion 13 becomes larger in the direction toward the downstream side in transportation direction DR1. Protruding surface 14 is provided at the downstream side relative to curvature surface portion 13 in transportation direction DR1. Curvature surface portion 13 is smoothly continuous to protruding surface 14 at downstream end 13b.

Protruding surface 14 has a shape protruding toward pressure roller 30. Protruding surface 14 protrudes to bite into pressure roller 30. Protruding surface 14 protrudes in a direction opposite to the direction in which curvature surface portion 13 protrudes. The curvature of protruding surface 14 is opposite to the curvature of curvature surface portion 13.

Protruding surface 14 has a curved shape. The curvature radius of protruding surface 14 is preferably more than or equal to 0.5 mm and less than or equal to 1.5 mm. The curvature radius of protruding surface 14 is 1.0 mm, for example. A protrusion downstream end 14b is provided at the most downstream portion of protruding surface 14 in transportation direction DR1 in cross section Z. Path adjustment surface 15 is provided at the downstream side relative to protruding surface 14 in transportation direction DR1. Protruding surface 14 is smoothly continuous to path adjustment surface 15 at protrusion downstream end 14b.

Path adjustment surface 15 may be a gradually curved surface, but is flat in the first embodiment. Path adjustment surface 15 extends along a direction of a tangent line L1 (L1 in FIG. 4) of protruding surface 14 at protrusion downstream end 14b. In the embodiment, the length (a in FIG. 4; hereinafter, referred to as “length a of fixing nip portion N”) of fixing nip portion N in transportation direction DR1 is 10 mm.

In cross section Z, the length (b in FIG. 4; hereinafter, referred to as “length b of path adjustment surface 15”) of path adjustment surface 15 in the direction along path adjustment surface 15 is preferably more than or equal to 1 mm and less than or equal to 3 mm. Length b of path adjustment surface 15 is 2.5 mm, for example. In cross section Z, length b of path adjustment surface 15 is equal to or less than ⅓ of length a of fixing nip portion N.

Path adjustment surface 15 has a portion corresponding to the most downstream portion (hereinafter, referred to as “nip exit No”) of fixing nip portion N in transportation direction DR1. In the present specification, the “portion corresponding to nip exit No” means a portion of facing surface 17 facing nip exit No. The portion corresponding to nip exit No may be provided at protrusion downstream end 14b.

A portion of path adjustment surface 15 faces a portion of fixing nip portion N. Path adjustment surface 15 is provided with: the portion facing fixing nip portion N; and a portion not facing fixing nip portion N.

The path in which sheet S is transported is defined to follow the surface shape of facing surface 17. Sheet S having entered from nip entrance Ni passes through fixing nip portion N, and is ejected from nip exit No. Then, sheet S is transported along the surface of path adjustment surface 15. Path adjustment surface 15 defines and adjusts the transportation path of sheet S.

Curved corner surface 16 is provided at the downstream side relative to path adjustment surface 15 in transportation direction DR1. Corner surface 16 is smoothly continuous to path adjustment surface 15. Corner surface 16 constitutes a chamfered portion of facing surface 17. The curvature radius of corner surface 16 is preferably more than or equal to 1.5 mm and less than or equal to 3.0 mm. In the embodiment, the curvature radius of corner surface 16 is 2.75 mm.

Corner surface 16 has a contact portion 16b at a portion to be in contact with fixing belt 20. In cross section Z, a first tangent line L4 of corner surface 16 and a second tangent line L5 of path adjustment surface 15 are defined. First tangent line L4 of corner surface 16 passes through a most downstream portion 16c of contact portion 16b in the rotation direction (direction of B in FIG. 4) of fixing belt 20, and second tangent line L5 of path adjustment surface 15 passes through a most downstream portion 15a of path adjustment surface 15 in the rotation direction of fixing belt 20. An angle β between first tangent line L4 and second tangent line L5 is more than or equal to 55° and less than or equal to 60°. In the embodiment, angle β therebetween is 57°.

As shown in FIG. 5, in cross section Z, path adjustment surface 15 is inclined relative to flat surface portion 12. Path adjustment surface 15 is more inclined relative to flat surface portion 12 in the direction toward pressure roller 30 as path adjustment surface 15 extends toward the downstream side in transportation direction DR1. In cross section Z, an angle α between an extension line L2 in the direction along flat surface portion 12 and an extension line L3 in the direction along path adjustment surface 15 is 3.3°, for example. Angle α therebetween is preferably more than or equal to 2.3° and less than or equal to 4.3°.

(Function and Effect)

Since path adjustment surface 15 is provided at the portion facing nip exit No as shown in FIG. 4, an ejection direction in which sheet S is ejected from nip exit No is defined. Sheet S is transported along the surface shape of path adjustment surface 15. Accordingly, the transportation path of sheet S can be stabilized. Therefore, sheet S can be transported in the intended ejection direction. Accordingly, excellent separability between sheet S and fixing belt 20 can be secured. Therefore, sheet jamming can be suppressed.

When length b of path adjustment surface 15 is too long, the toner image fixed to sheet S having been ejected from nip exit No is supplied with an excessive amount of heat at path adjustment surface 15, with the result that a problem may occur such as a decreased gloss level, hot offset (a phenomenon in which the toner image fixed once is heated again to be detached from the sheet), or the like.

In cross section Z, length b of path adjustment surface 15 is less than or equal to ⅓ of length a of fixing nip portion N. Accordingly, at the time of fixing, a period of time during which sheet S is in contact with path adjustment surface 15 can be kept smaller than a period of time during which sheet S passes through fixing nip portion N. Therefore, an excessive amount of heat can be suppressed from being supplied to sheet S while sheet S is transported along path adjustment surface 15. This makes it possible to suppress decreased gloss level and occurrence of hot offset of sheet S.

In fixing device 1 of the embodiment, an excessive amount of heat can be suppressed from being supplied to sheet S, without providing a new mechanism. Therefore, an excessive amount of heat can be suppressed in a simplified manner from being supplied to the toner image, while securing separability.

Path adjustment surface 15 is preferably flat (curvature≈0). Sheet S is transported to follow the surface shape of path adjustment surface 15. Since path adjustment surface 15 is flat, sheet S is transported straightly along path adjustment surface 15. Accordingly, the transportation path of sheet S can be stabilized more. Further, an amount of bending of sheet S along path adjustment surface 15 can be suppressed.

Path adjustment surface 15 may be a gradually curved surface having a curvature smaller than pressure roller 30 or curvature surface portion 13. Even when path adjustment surface 15 is such a gradually curved surface, the effect of suppressing an excess amount of heat from being supplied to the toner image while securing separability is obtained.

When length b of path adjustment surface 15 is smaller than 1.0 mm, the period of time during which sheet S is in contact with path adjustment surface 15 is short and sheet S is less likely to be transported in the direction along path adjustment surface 15, with the result that sheet S is less likely to be ejected in the intended ejection direction. When length b of path adjustment surface 15 is larger than 3.0 mm, the period of time during which path adjustment surface 15 and sheet S are in contact with each other becomes too long, with the result that an excessive amount of heat may be supplied to the toner image already fixed on sheet S. By setting length b of path adjustment surface 15 to be more than or equal to 1 mm and less than or equal to 3 mm in cross section Z, an excessive amount of heat can be suppressed securely from being supplied to the toner image while securing separability.

By providing curved surface 11 at the upstream side relative to nip entrance Ni in transportation direction DR1, sheet S transported toward nip entrance Ni is drawn into the rotation of fixing belt 20 when coming into contact with fixing belt 20, whereby sheet S is facilitated to enter fixing nip portion N.

Flat surface portion 12 is provided at the upstream side relative to path adjustment surface 15 in transportation direction DR1. Flat surface portion 12 is a region for melting the toner image by supplying heat to the toner image on sheet S. By providing flat surface portion 12 having the portion facing nip entrance Ni, a nip pressure at the upstream side (in the vicinity of nip entrance Ni) of fixing nip portion N can be maintained to be low.

By providing curvature surface portion 13 at nip formation member 10, a pressure distribution in which pressure is increased gradually in a direction from upstream end 13a of curvature surface portion 13 toward downstream end 13b can be formed at fixing nip portion N.

The curvature radius of curvature surface portion 13 is larger than the curvature radius of pressure roller 30. Accordingly, a degree of nip formation member 10 biting into pressure roller 30 can be reduced. Therefore, pressure can be suppressed from being increased abruptly.

Protruding surface 14 is provided at the upstream side relative to path adjustment surface 15 in transportation direction DR1. Protruding surface 14 is a portion with the highest pressure in fixing nip portion N. Protruding surface 14 pushes the toner, melted at flat surface portion 12 and curvature surface portion 13, onto sheet S in a high pressure state. Accordingly, excellent fixability can be secured.

At fixing nip portion N, a nip pressure distribution is as follows: the pressure is comparatively low at flat surface portion 12, is increased from curvature surface portion 13, and is the highest at protruding surface 14. The toner image transferred to sheet S and not having been fixed yet is supplied with heat at flat surface portion 12 and curvature surface portion 13 and is accordingly melted, and the melted toner image is pushed onto and fixed to sheet S at the high pressure region of protruding surface 14. Since nip formation member 10 employs such a configuration that different functions are provided for the upstream portion (low pressure region) and the downstream portion (high pressure region) of fixing nip portion N, excellent fixability can be obtained even when a load acting on fixing nip portion N is low.

The curvature radius of protruding surface 14 is preferably more than or equal to 0.5 mm and less than or equal to 1.5 mm. Accordingly, damage on fixing belt 20 can be reduced.

When the curvature radius of corner surface 16 is small, fixing belt 20 is likely to be cracked, whereas when the curvature radius of corner surface 16 is large, separability of sheet S is deteriorated. By setting the curvature radius of corner surface 16 to be more than or equal to 1.5 mm and less than or equal to 3.0 mm, separability can be secured while maintaining durability of fixing belt 20.

When angle β between first tangent line L4 and second tangent line L5 is small, separability between sheet S and fixing belt 20 is deteriorated, whereas when angle β therebetween is large, cracking due to deflection of fixing belt 20 takes place. By setting angle β therebetween to be more than or equal to 55° and less than or equal to 60°, separability can be improved while maintaining durability of fixing belt 20.

As shown in FIG. 5, path adjustment surface 15 is inclined relative to flat surface portion 12. Accordingly, sheet S can be effectively separated from fixing belt 20.

Path adjustment surface 15 is inclined more in the direction toward pressure roller 30 as path adjustment surface 15 extends toward the downstream side relative to flat surface portion 12 in transportation direction DR1. This leads to suppression of jamming, which occurs particularly when a thin sheet is adhered to fixing belt 20.

When angle α between extension line L2 and extension line L3 is larger than 4.3°, sheet S to be ejected from nip exit No is likely to be drawn to pressure roller 30. Hence, in cross section Z, angle α therebetween is preferably more than or equal to 2.3° and less than or equal to 4.3°. Accordingly, sheet S can be separated from fixing belt 20 more effectively.

### Second Embodiment

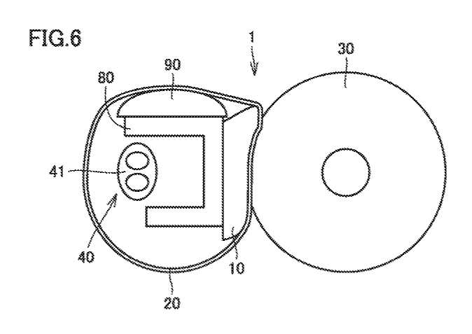

FIG. 6 is a schematic cross sectional view showing a fixing device 1 in a second embodiment. Unlike the first embodiment, fixing belt 20 is not laid in a tensioned manner Fixing device 1 of the first embodiment employs the two-axis belt configuration in which fixing belt 20 is tensioned and laid on nip formation member 10 and heating roller 42; however, a one-axis belt configuration may be used as in fixing device 1 of the second embodiment.

Also in fixing device 1 of the second embodiment, with the simple configuration, there is obtained the effect of suppressing an excess amount of heat from being supplied to the toner image while securing separability, as with fixing device 1 of the first embodiment.

### EXAMPLES

Hereinafter, examples will be described. As the examples, nip formation members having different ratios (hereinafter, each referred to as “nip ratio (b/a)”) of lengths b of path adjustment surfaces to lengths a of fixing nip portions were produced (Example 1 and Example 2 as well as Comparative Example 1 to Comparative Example 4). Each of the nip formation members was placed on an evaluation machine to conduct a test for evaluating separability and gloss level.

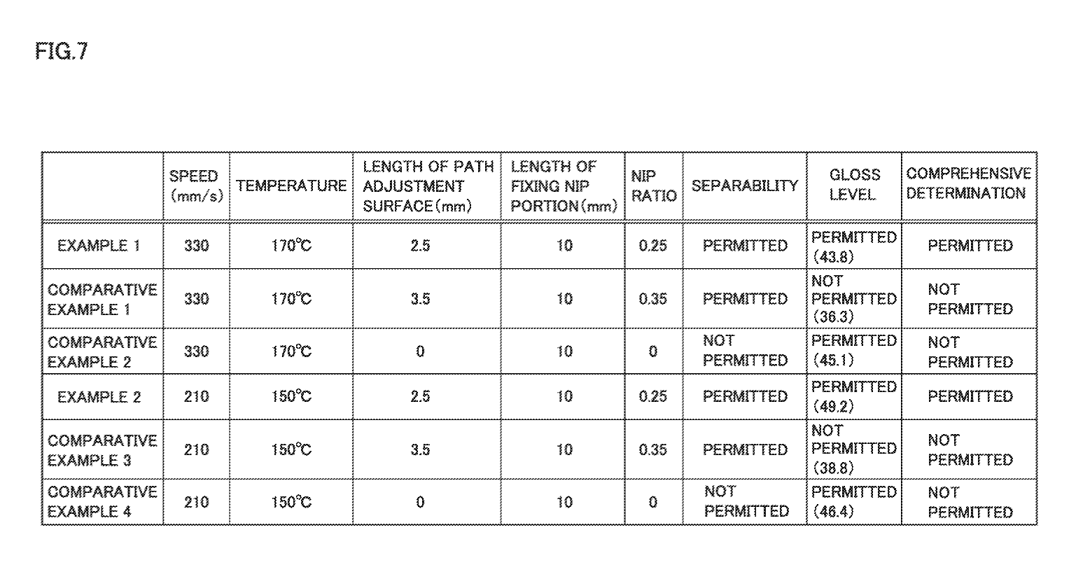

FIG. 7 shows a table showing evaluation results for the respective nip formation members of Example 1, Example 2 and Comparative Example 1 to Comparative Example 4. “NOT PERMITTED” in the column for the separability in FIG. 7 indicates that the separability of sheet was insufficient, whereas “PERMITTED” indicates that the separability was excellent.

“NOT PERMITTED” in the column for the gloss level in FIG. 7 indicates that the gloss level was less than a permissible value and quality was poor (hot offset occurred). “PERMITTED” indicates that the gloss level satisfied a requirement of the gloss level and the quality was excellent. In the column for determined results of the gloss levels, respective values of the gloss levels are put in parenthesis.

In each of Comparative Example 2 and Comparative Example 4 (nip ratio of 0), a nip formation member provided with no path adjustment surface was employed. In Comparative Example 2 and Comparative Example 4 in each of which no path adjustment surface was provided, the separability was insufficient. In Comparative Example 1 and Comparative Example 3 in each of which the nip ratio (b/a) was larger than ⅓, the separability was excellent but the gloss level was less than the permissible value. In Example 1 and Example 2 in each of which the nip ratio (b/a) was smaller than ⅓, excellent results were obtained for both the separability and the gloss level.

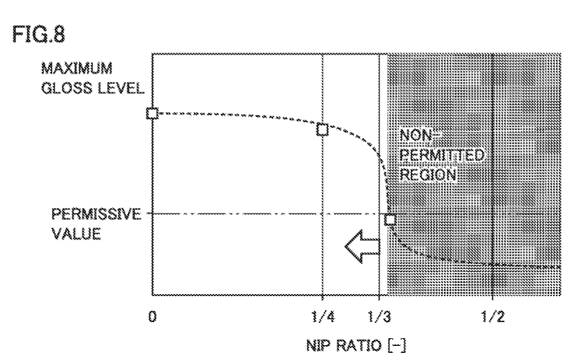

FIG. 8 shows a graph for determining the nip ratio satisfying the requirement of the gloss level. Based on each of the results of the Examples and the Comparative Examples (the nip ratios were 0, 0.25, and 0.35), an approximated curve (dotted line in FIG. 8) was created to determine a nip ratio satisfying the requirement of the gloss level (exceeding the permissible value). It is understood that as shown in FIG. 8, when the nip ratio (b/a) is larger than ⅓, the permissible value of the gloss level is exceeded, thus satisfying the requirement of the gloss level.

It was indicated that by setting length b of path adjustment surface 15 to be less than or equal to ⅓ of length a of fixing nip portion N as described above, an excessive amount of heat can be suppressed from being supplied to the toner image while securing separability, thereby suppressing reduction of the gloss level.

(Other)

It should be noted that fixing device 1 of the embodiment may be provided with a heating roller that faces nip formation member 10 disposed at the inner circumferential side of fixing belt 20 having an endless form and that faces the outer circumferential surface of fixing belt 20. In such a configuration, the rotation body is the heating roller.

The above-described fixing device according to the present disclosure fixes a toner image to a recording medium. The fixing device includes: a fixing belt having an endless form and configured to be rotatable; a nip formation member; a rotation body; and a heater. The nip formation member is disposed at an inner circumferential side of the fixing belt. The rotation body is configured to form a fixing nip portion with the rotation body facing the nip formation member and facing an outer circumferential surface of the fixing belt. The heater is configured to supply heat to the toner image. The nip formation member includes a path adjustment surface having a portion corresponding to a most downstream portion of the fixing nip portion in a transportation direction of the recording medium. In a cross section of the nip formation member orthogonal to a width direction of the fixing belt, a length of the path adjustment surface in a direction along the path adjustment surface is less than or equal to ⅓ of a length of the fixing nip portion in the transportation direction.

In the fixing device, the path adjustment surface is flat.

In the fixing device, in the cross section of the nip formation member orthogonal to the width direction, the length of the path adjustment surface in the direction along the path adjustment surface is more than or equal to 1 mm and less than or equal to 3 mm.

In the fixing device, the nip formation member has a curved surface at an upstream side relative to the fixing nip portion in the transportation direction.

In the fixing device, the nip formation member includes a curvature surface portion curved at an upstream side relative to the path adjustment surface in the transportation direction. The curvature surface portion has such a shape that the curvature surface portion extends to come closer to a center of the rotation body as the curvature surface portion extends toward a downstream in the transportation direction in the cross section of the nip formation member orthogonal to the width direction.

In the fixing device, the nip formation member includes a curvature surface portion curved at the upstream side relative to the path adjustment surface in the transportation direction. A curvature radius of the curvature surface portion is larger than a curvature radius of the rotation body.

In the fixing device, the nip formation member has a flat surface portion at an upstream side relative to the path adjustment surface in the transportation direction.

In the fixing device, the path adjustment surface is inclined relative to the flat surface portion.

In the fixing device, the path adjustment surface is more inclined relative to the flat surface portion in a direction toward the rotation body as the path adjustment surface extends toward a downstream side in the transportation direction. An angle between the path adjustment surface and the flat surface portion is more than or equal to 2.3° and less than or equal to 4.3°.

In the fixing device, the nip formation member includes a protruding surface smoothly continuous to the path adjustment surface at the upstream side relative to the path adjustment surface in the transportation direction. The protruding surface has a shape protruding toward the rotation body.

In the fixing device, a curvature radius of the protruding surface is more than or equal to 0.5 mm and less than or equal to 1.5 mm.

In the fixing device, the nip formation member includes a corner surface curved at a downstream side relative to the path adjustment surface in the transportation direction. A curvature radius of the corner surface is more than or equal to 1.5 mm and less than or equal to 3.0 mm.

In the fixing device, the corner surface has a contact portion at a portion to be in contact with the fixing belt. In the cross section of the nip formation member orthogonal to the width direction, a first tangent line of the corner surface and a second tangent line of the path adjustment surface are defined, the first tangent line passing through a most downstream portion of the contact portion in a rotation direction of the fixing belt, the second tangent line passing through a most downstream portion of the path adjustment surface in the rotation direction. An angle between the first tangent line and the second tangent line is more than or equal to 55° and less than or equal to 60°.

An image forming apparatus according to the present disclosure includes: the above-described fixing device according to any one of the above-described aspects; and an accommodation portion configured to store the recording medium.

Although embodiments of the present invention have been described and illustrated in detail, it is clearly understood that the same is by way of illustration and example only and not limitation, the scope of the present invention should be interpreted by terms of the appended claims.

What is claimed is:

1. A fixing device for fixing a toner image to a recording medium, the fixing device comprising:
a fixing belt having an endless form and configured to be rotatable;
a nip formation member disposed at an inner circumferential side of the fixing belt;
a rotation body configured to form a fixing nip portion with the rotation body facing the nip formation member and facing an outer circumferential surface of the fixing belt; and
a heater configured to supply heat to the toner image, wherein
the nip formation member includes a path adjustment surface having a portion corresponding to a most downstream portion of the fixing nip portion in a transportation direction of the recording medium, and
in a cross section of the nip formation member orthogonal to a width direction of the fixing belt, a length of the path adjustment surface in a direction along the path adjustment surface is less than or equal to ⅓ of a length of the fixing nip portion in the transportation direction.

2. The fixing device according to claim 1, wherein the path adjustment surface is flat.

3. The fixing device according to claim 1, wherein in the cross section of the nip formation member orthogonal to the width direction, the length of the path adjustment surface in the direction along the path adjustment surface is more than or equal to 1 mm and less than or equal to 3 mm.

4. The fixing device according to claim 1, wherein the nip formation member has a curved surface at an upstream side relative to the fixing nip portion in the transportation direction.

5. The fixing device according to claim 1, wherein
the nip formation member includes a curvature surface portion curved at an upstream side relative to the path adjustment surface in the transportation direction, and
the curvature surface portion has such a shape that the curvature surface portion extends to come closer to a center of the rotation body as the curvature surface portion extends toward a downstream in the transportation direction in the cross section of the nip formation member orthogonal to the width direction.

6. The fixing device according to claim 1, wherein
the nip formation member includes a curvature surface portion curved at the upstream side relative to the path adjustment surface in the transportation direction, and
a curvature radius of the curvature surface portion is larger than a curvature radius of the rotation body.

7. The fixing device according to claim 1, wherein the nip formation member has a flat surface portion at an upstream side relative to the path adjustment surface in the transportation direction.

8. The fixing device according to claim 7, wherein the path adjustment surface is inclined relative to the flat surface portion.

9. The fixing device according to claim 8, wherein
the path adjustment surface is more inclined relative to the flat surface portion in a direction toward the rotation body as the path adjustment surface extends toward a downstream side in the transportation direction, and
an angle between the path adjustment surface and the flat surface portion is more than or equal to 2.3° and less than or equal to 4.3°.

10. The fixing device according to claim 1, wherein
the nip formation member includes a protruding surface smoothly continuous to the path adjustment surface at the upstream side relative to the path adjustment surface in the transportation direction, and
the protruding surface has a shape protruding toward the rotation body.

11. The fixing device according to claim 10, wherein a curvature radius of the protruding surface is more than or equal to 0.5 mm and less than or equal to 1.5 mm.

12. The fixing device according to claim 1, wherein
the nip formation member includes a corner surface curved at a downstream side relative to the path adjustment surface in the transportation direction, and
a curvature radius of the corner surface is more than or equal to 1.5 mm and less than or equal to 3.0 mm.

13. The fixing device according to claim 12, wherein
the corner surface has a contact portion at a portion to be in contact with the fixing belt,
in the cross section of the nip formation member orthogonal to the width direction, a first tangent line of the corner surface and a second tangent line of the path adjustment surface are defined, the first tangent line passing through a most downstream portion of the contact portion in a rotation direction of the fixing belt, the second tangent line passing through a most downstream portion of the path adjustment surface in the rotation direction, and
an angle between the first tangent line and the second tangent line is more than or equal to 55° and less than or equal to 60°.

14. An image forming apparatus comprising:
the fixing device recited in claim 1; and
an accommodation portion configured to store the recording medium.
